(19) United States
(12) Patent Application Publication
(10) Pub. No.: US 2004/0100486 A1
(43) Pub. Date: May 27, 2004

(54) Method and system for image editing using a limited input device in a video environment

(76) Inventors: Andrea Flamini, Jackson County, MO (US); Amy Langlois, King County, WA (US); Randy Moss, King County, WA (US)

Correspondence Address: James L Davison, PictureIQ Corporation, Suite 1601, 600 Stewart Street, Seattle, WA, 98101, US

(21) Appl. No.: 10/181,287

(22) PCT Filed: Feb. 7, 2001
(86) PCT No.: PCT/US01/04052

(51) Int. Cl. G09G 5/00

(52) U.S. Cl. 345/723

(57) ABSTRACT

A method of using a limited input device (300) to navigate through a plurality of user interface (UI) control elements (504) overlaying a video content field (502) is disclosed. A room is identified. In the described embodiment, the room is a specific set of plurality of UI control elements that, taken together, allow a user to perform a related set of activities using the limited input control device. Once the room is identified, using the limited input control device (300), moving between those of the plurality of UI control elements (502) that form a first subset of the specific set of UI control elements that form the identified room using the limited input control device (300). A first action corresponding to a particular active UI control element of the first subset is executed based upon an input event provided by the limited input device (300).

### BACKGROUND OF THE INVENTION

1. Field of Invention The invention relates generally to real-time video imaging systems. More particularly, methods and apparatus are provided for an interactive TV application using a limited input device and user interface objects that are layered over a user's real-time defined content, such as video or digital photos.

2. Description of Relevant Art

Traditional Windows applications make heavy use of opaque overlapping windows for the design of the application and rely on a pointing device, typically a mouse, for navigation and control of the application. In general, additional windows or dialog boxes are displayed to accept additional user input and in turn can effect the underlying user content. The mouse is used as the primary form of navigation within and between these windows with the keyboard as a secondary means of input. This interaction can be dynamic and in real-time, but there is a complete separation between the content being interacted with and the user controls.

While this paradigm is standard and expected for Windows applications there are several drawbacks. First and foremost, the amount of screen real estate required is significantly increased. Some refer to this as the “port hole effect” where the user's content is in a small hole in the middle of the screen surrounded by opaque menus and other controls. While this is not much of a problem with larger displays such as 1024×768 pixels or larger, it is almost impossible if displayed on a television which has much less resolution then even the lowest standard VGA resolution (640×480). In this situation, there will be very little room for the user to view and manipulate their content (i.e. photos, video, etc.).

Further issues complicate this problem since up to a 15% safe-area must be allocated in the actual design in addition to the fact that the NTSC broadcast single is interlaced. This results in an actual maximum screen resolution of approximately 550×400 pixel. Clearly, overlapping opaque windows is not an acceptable solution for graphical user interface design for an interactive TV application.

An addition issue of the actual “look” of the application can not be dismissed. An application being designed for a television, viewed in a living room environment, may not provide the “best” user experience if a standard Windows application approach is taken. In general, broadcast TV systems and interactive TV applications take the approach of layering static information on top of the video signal, there by emphasizing the actual content instead of the user interface elements.

As for pointer based navigation, the main drawback is that if no pointing device is available, control of the application is difficult if not impossible. For example, try to start Windows, launch an application and perform some amount of work when the mouse is not attached to the computer. This is a challenging task.

If a PC application were ported to run on a device connected to a television and controlled through a limited input remote control device, special key sequences (remote control buttons) could be programmed to control the application. Unfortunately, such an approach would be truly awkward and would discourage most users from using the product. The invention outlined in this document describes an alternative approach for controlling a complete application without the use of a mouse or other pointing device. Even if a mouse were available, this approach would be preferable since it is much more intuitive and easier for the user to control the navigation of the user interface for this type of computing appliance or application.

For example, in FIG. 1, a conventional NTSC standard TV picture 100 is shown that includes an active picture region 102 that is the area of the TV picture 100 that carries picture information. Outside of the active picture region 102 is a blanking region 104 suitable for line and field blanking. The active picture region 102 uses a frame 106 that include pixels 108 arranged in scan lines 110 to form the actual TV image. The frame 106 represents is a single image in a sequence of images that are produced from any of a variety of sources such as an analog video camera, digital still or video camera, various information appliances such as WebTV, AOL-TV, as well as various game consoles that include those manufactured by Sega, Sony, and Nintendo, and even standard PCs. In systems where interlaced scan is used, each frame 106 represents a field of information, but may also represent other breakdowns of a still image depending upon the type of scanning being used. It should be noted, that in general, the typical size of the frame 106 is much smaller then that the active picture region 102 due, in part, to a screen safe area that is typically about 15% of the total screen area.

Referring now to FIG. 2, the active picture region 102 includes a displayed image 112 included in the frame 106. It should be noted that the maximum resolution of standard NTSC video signal is substantially less than 512 scanlines (i.e., at most only 487 active scanlines after taking into account the blanking region 104 and the safe area) and that the resolution of the displayed image 112 is further reduced due to the fact that the video signal is interlaced. In order to reduce flicker (due to the refreshing of interlaced frames), all single pixel lines must be removed from user interface elements 114-124. It is due, in part, to this reduction in display resolution that when using an image manipulation program to, for example, edit or otherwise enhance a digital photograph, it is important to be able to provide a “full screen” display of the image 112. By full screen, it is meant that the user's work area takes up the entire active area 102. It should be noted, however, that even though the full active area 102 can be utilized for displaying content such as a photo, important parts of any user interface element should not be displayed in this area since it may not be visible. User interface elements must be contained within frame 106 to guarantee visibility on all television sets.

Using a conventional approach to displaying user interface elements, the active picture region 102 is typically sub-divided into a number of containers 126-132 superimposed over the displayed image 112, which in this example is a map of the world. A container represents a displayable region of the TV picture 100 dedicated to certain user interface elements. Such elements include, UI elements 114 and 116 in container 126 and vertical bars 134 in container 132 that are used to indicate the relative increase or decrease in, for this example, the volume of the audio signal produced. In addition to these static containers, container 130 is an opaque, movable container that can slide in and out of view as required.

In addition to reducing the available work area, the segmentation of the image 112 into containers makes navigating between the various UI elements, such as between UI element 114 and UI element 124 that are each included in different containers, extremely difficult and time consuming. This is especially true considering those standard PC navigation tools, such as mouse or trackball, which are unwieldy and difficult to use in conjunction with a standard TV system. Typically, a standard TV remote control unit 300, shown in FIG. 3, having only a limited number of input keys, is used as the primary navigation tool. Since most TV remote controls have a limited number of input pads, the number of possible navigational instructions can be quite limited. By way of example, the remote control unit 300 includes 4 directional buttons, up 302, down 304, right 306, and left 308 as well as an enter button 310 and a back button 312. Referring back to FIG. 2, using only the remote 300 as a navigation tool requires substantial effort and patience to navigate between the various UI elements 114-124. For example, in order to move a cursor 136 from the UI element 114 (in container 126) to UI element 124 (in container 130) requires 5 keystrokes on the remote control 300, namely, keystroke 1 is UP, keystroke 2 is UP, keystroke 3 is RIGHT, keystroke 4 is RIGHT, and keystroke 5 DOWN.

Restricting movement between containers makes navigation through the various UI elements (also referred to as icons) present in most Windows based image manipulation programs controlled by a non-pointing based input device very difficult, time consuming, and wearisome. This reduces the desirability of using image editing programs on standard TVs using only a standard remote control unit.

In addition to the size reduction of the actual viewing area, the “look” of the application cannot be dismissed. An application being designed for a television, viewed in a living room environment, may not provide the “best” user experience if a standard Windows application approach is taken. In general, broadcast TV systems and interactive TV applications take the approach of layering static information over top of the video signal, there by emphasizing the importance of the actual content, as opposed to the user interface elements as with a traditional Windows application.

All of these inventions have the comparable goal of facilitating the editing of digital images. The difference between this invention and these existing PC applications is that this invention allows this work to be done in a broadcast television/video game environment rather than a desktop PC environment. The key differences here are the display device (TV vs. Monitor), input device (remote control vs. pointing device such as a mouse, and the style of the UI.

Standard broadcast TV takes an entirely different approach, one much more in line with the design decisions described in this invention. The broadcast video signal is of primary importance and takes over the entire screen of the TV set. In general, this is what one would expect when maximizing screen real estate. Informational elements are displayed on top of the video signal. In broadcast TV, the composition of these is handled at the origin of the video signal. For instance, sport scores are passive elements that are overlaid on top of the signal. Another, more dynamic, example is the “replay white board” where, for example, a sportscaster draws on top of the screen to illustrate what happened during a replay. While this is more dynamic than the simple sports score scenario, it does not affect the actual video signal (it is composited together), nor does it allow the user to interact with the content. While this invention takes a similar approach, overlaying user element controls on top of the video signal or other content, it also allows the end user to dynamically interact with the content.

Some standard television and VCR user interfaces take over the entire screen, such as a blue screen with white text for setup and configuration, while others allow the user to make adjustments to the overall settings visually in real-time. The former is not of interest since the user is not interacting with the video stream in real time. However, the latter scenario must be further examined.

One interface for modification of the brightness and contrast setting involves displaying a set of bars indicating the amount of brightness and contrast. Using the remote control, the user can adjust the overall brightness and contrast of the video signal. While it is true the user is interacting with the video image, he is actually changing the underlying television display controls that affect the video stream. He is not actually modifying the content of the video stream. This is an important distinction since modifying the content (as provided by this invention) is a significantly more complex operation.

The approach embodied by the present invention allows the user to directly manipulate the video stream or other content using a remote control. This modification results in processing the video stream or other content in real-time, which in turn causes subsequent processing, and updates to the display. In addition, the edited video stream or content may be saved.

Standard television and VCR user interfaces make use of a limited input remote control device. While these devices may make use of up/down/left/right/forward (enter)/back (cancel), they are generally limited to setup and program information. It is clear, however, if the user model for these devices were extended to navigational support for a more complex application, this model would quickly break down.

For a Canon photo appliance product, the screen is broken up into several areas and the navigation of the user interface is provided by a remote control device (up/down/left/right/forward/back). Despite this similarity, it is significantly more complex and confusing to the user compared to the techniques as embodied by the invention. The left side contains menu options, the bottom controls additional options, the middle contains even more commands or the user's content. This is the “port hole effect” as described above. As with many interfaces that make use of simple directional inputs found on a remote control device, directional arrows allow the user to move around all the controls on the entire screen. While each area organizes its commands for a specific purpose, the user is free to navigate around the entire screen. The interface does nothing to prevent the user from moving from one container to another. Further, no attempt is made to “guide” the user from one area of the interface to another. Free form control of the application, while it is the ultimate in flexibility, it is overly complex and confusing to the user since the user receives little or no guidance regarding the plethora of options available.

The approach embodied in the present invention provides for the user interface to automatically and dynamically control where the user should go next in the interface, and hence allows the user to quickly perform the desired operation and minimizes the “mean number of clicks to gratification.” More importantly, the user is guided to the correct location in the user interface allowing less mistakes and frustration.

Avicor developed a photo appliance, which takes a standard floppy as input for images and provides for simple album management. The interface is similar to Canon's in that the user interface is generally free form since the user can navigate around the entire interface. While for this product, the interface is not that confusing, it is primarily due to its limited functionality. If additional functionality were added, navigation would quickly become unmanageable.

TiVo and Replay offer an “advanced digital video recorder” that allows many hours of video sequences to be recorded on a single device. Each of these use a blend of interfaces as described earlier. Some on-screen programming makes use of overlaid program information (i.e. on-line TV guide) that is composited (alpha-blended) on top of the TV signal. The user is also able to “program” the device to specify what should be recorded as well as other setup information. While the “end-user” is programming the device, they are not effecting or interacting with the actual broadcast video content, beyond programming the device to record the specified program.

WebTV is an information appliance that allows the user to navigate the Web using a standard television and a remote control device. Recently, WebTV has announced WebPIP (picture-in-picture) that allows a user to browse the Web while watching TV. For this case, a smaller picture is overlaid (opaquely) on top of the full-screen broadcast video signal. It clearly does not allow the user to update the video content beyond displaying of a new opaque web page in the picture-in-picture region.

Navigation is controlled using the simple directional inputs (up/down/left/right/forward/back). This model maps very closely to the way a user navigates the Web using a standard browser (Microsoft Internet Explore or Netscape Communicator). The WebTV server will dynamically create a page that a user can navigate by simple directional movements. For example, up/down/left/right buttons allow the user to navigate around the links or hot spots on a given Web page. It also allows the user to “follow” the link or execute a command using “forward”, and “back” allows the user to return from a link or cancel an operation (such as to close a dialog box).

Beyond navigation within Web pages, the remote control is used for entering letters into an on-screen keyboard, and accepting and canceling dialog boxes. It is not used for navigation between many different UI controls or the general flow of a complex application, beyond what is described above.

DVD players also provide some Interactive TV behavior. On a given DVD, the user is able to change to different segments of a movie (in real-time), switch to different languages, turn on/off subtitles, or listen to interviews. Although the user can interact with the DVD, they cannot make changes to the video content, beyond switching between several “pre-defined” movies or settings. This sort of interaction is much more like the traditional TV setup or VCR programming.

Therefore, what is desired is an efficient method and apparatus for displaying graphical user interface elements that interact and dynamically update both user-defined and pre-rendered content on a non-PC display, which affords easy navigation and provides full screen display capabilities to the end user without obscuring the displayed image.

Some digital cameras available today display menus and other status information overlaid on top of a photograph. An example of this is the Kodak DC260 Zoom camera. While in review mode viewing a photo stored on the digital film, the camera display shows the photo number, date and time in a strip on the top of the photo. Overlaid on the bottom of the photo are the currently available options such as delete and magnify. The user selects an option by pressing the corresponding button on the camera body and changes photos by pressing the navigation buttons on the camera body.

Therefore, what is desired is an efficient method and apparatus for displaying graphical user interface elements (icons) that interact and dynamically update both user-defined and pre-rendered content on a non-PC display which affords easy navigation and provides full screen display capabilities to the end user without obscuring the displayed image.

### BRIEF DESCRIPTION OF THE DRAWINGS

The invention, together with further advantages thereof, may best be understood by reference to the following description taken in conjunction with the accompanying drawings.

FIG. 1 shows a conventional NTSC standard TV picture 100 is shown that includes an active picture region 102 that is the area of the TV picture 100 that carries picture information.

FIG. 2 shows an active picture region that includes a displayed image included in the frame shown in FIG. 1.

FIG. 3 shows a standard TV remote control unit.

FIG. 4 shows a block diagram of a TV system arranged to process images displayed thereon in accordance with an embodiment of the invention.

FIG. 5A illustrates the digital imaging application screen generated by the photo information appliance in accordance with an embodiment of the invention.

FIG. 5B is an exemplary working image displayed on the content viewer in accordance with an embodiment of the invention.

FIG. 5C shows an expanded list of thumbnails referred to as a grid in accordance with an embodiment of the invention.

FIG. 6 illustrates an option bar and list state diagram in accordance with an embodiment of the invention.

FIG. 7 shows a tool state diagram in accordance with an embodiment of the invention is shown.

FIG. 8 illustrates a type 1 manipulator state diagram in accordance with an embodiment of the invention.

FIG. 9 illustrates a type 2 manipulator state diagram in accordance with an embodiment of the invention.

FIG. 10 illustrates a menu state diagram in accordance with an embodiment of the invention.

FIG. 11 shows an exemplary the reframe manipulator UI in accordance with an embodiment of the invention.

FIG. 12, illustrates how an SRT manipulator combines the actions of scale, rotate and translate of a selected clipart into one easy to use tool in accordance with an embodiment of the invention.

FIG. 13 shows a warp stamp manipulator in accordance with an embodiment of the invention.

FIGS. 14A, 14B and 14C illustrate how to remove red eye manipulator UI guides the user to click on as many red eyes as are present in the current photo in accordance with an embodiment of the invention.

FIG. 15 illustrating a functional block diagram of a particular implementation of the photo information appliance.

FIG. 16 is a flowchart detailing a process for displaying an image in accordance with an embodiment of the invention.

FIG. 17 details a process for performing an operation on the displayed image in accordance with an embodiment of the invention.

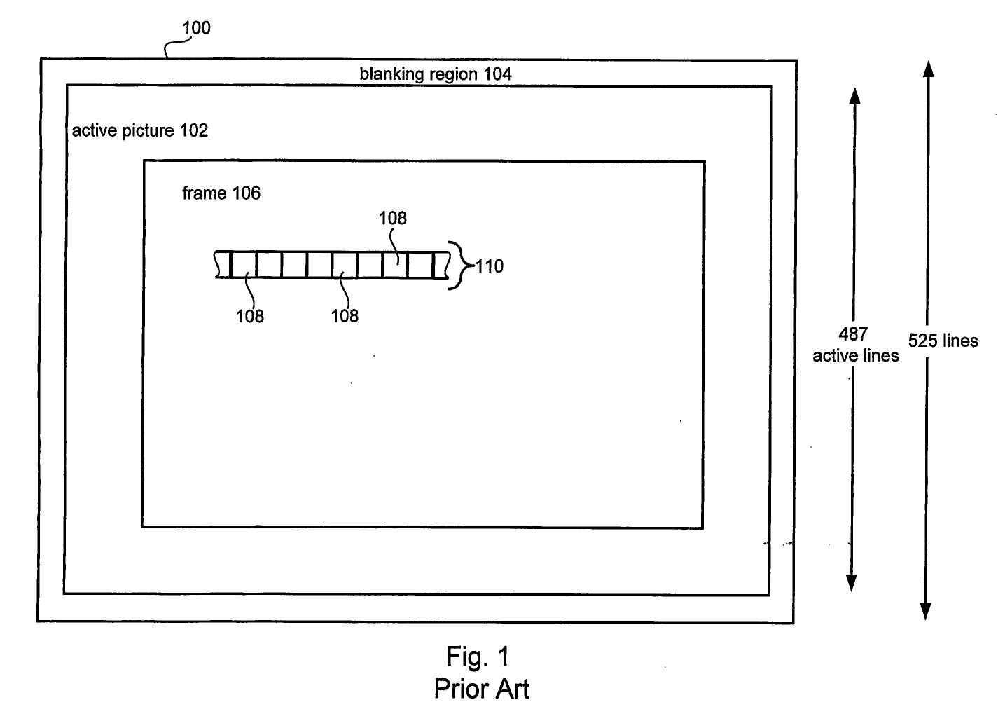

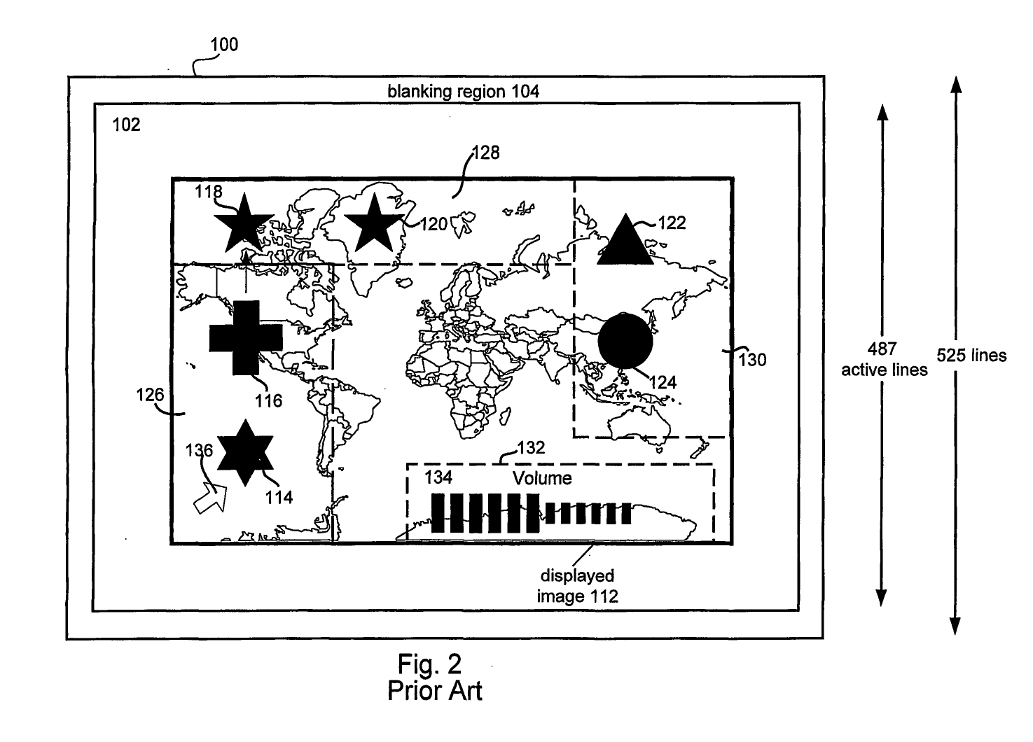

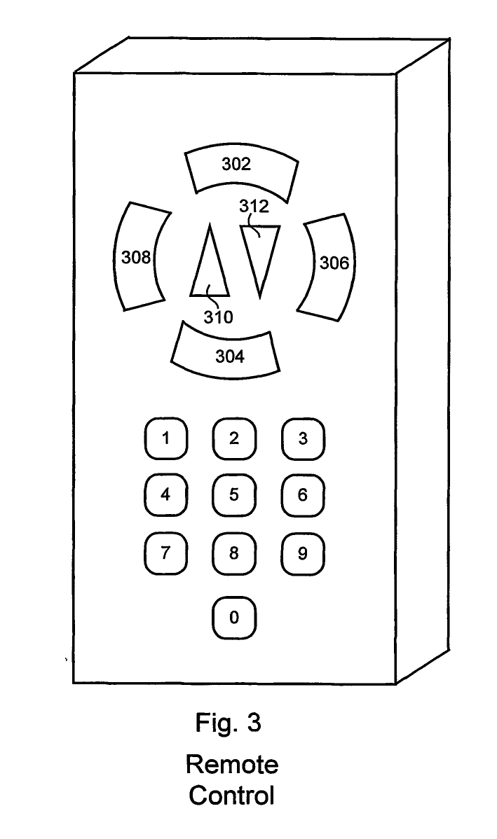

### SUMMARY OF THE INVENTION

The invention relates to an improved method, apparatus and system for image editing using a limited input device in a video environment.

In one aspect of the invention, a method of using a limited input device to navigate through a plurality of user interface (UI) control elements overlaying a video content field is disclosed. A room is identified. In the described embodiment, the room is a specific set of the plurality of UI control elements that, taken together, allow a user to perform a related set of activities using the limited input control device. Once the room is identified, using the limited input control device, moving between those of the plurality of UI control elements that form a first subset of the specific set of UI control elements that form the identified room using the limited input control device. A first action corresponding to a particular active UI control element of the first subset is executed based upon an input event provided by the limited input device.

In another aspect of the invention, computer-readable medium containing programming instructions for using a limited input device to navigate through a plurality of user interface (UI) control elements included in a video content field, the computer-readable medium comprising computer program code arranged to cause a host computer system to execute the operations is disclosed.

### DETAILED DESCRIPTION OF THE EMBODIMENTS

Some of terms used herein are not commonly used in the art. Other terms have multiple meanings in the art. Therefore, the following definitions are provided as an aid to understanding the description that follows. The invention as set forth in the claims should not necessarily be limited by these definitions.

The term “control” is used throughout this specification to refer to any user interface (UI) element that responds to input events from the remote control. Examples are a tool, a menu, the option bar, a manipulator, the list or the grid described below.

The term “option” is used throughout this specification to refer to an icon representing a particular user action. The icon can have input focus, which is indicated by a visual highlight and implies that hitting a designated action key on the remote control will cause the tool to perform its associated task.

The term “edit” includes all the standard image changing actions such as “Instant Fix”, “Red Eye Reduction”, rotating, cropping, warping, multiple image composition, light and contrast balancing, framing, adding captions and balloons and the other techniques that are well known in the art.

In the described embodiment, there are described three types of options: Navigation (Menu)—takes you to another room; Modeless (Tool)—performs a function such as rotate or instant fix with no further user input, and Modal (Manipulator)—requires further user input before performing function.

The term “Option bar” is used throughout this specification to refer to a linear list of options, having either a horizontal or vertical orientation. A user can navigate between Options in the list by pressing designated previous and next keys on the remote control or, depending on the configuration of the remote, perhaps up/down or left/right. The term “Manipulator” is used throughout this specification to refer to a modal option allowing a user to change some characteristic of a target digital image. A manipulator consists of an Option icon, a visual component, and a behavior and feedback. The visual component is overlaid upon the digital image indicating the characteristic being changed. The behavior is defined for a sequence of inputs from the remote control. The feedback is real-time visual feedback as inputs are received. Different manipulators are used to, for example, change image contrast, crop the image, and change positioning of images to create a composite image. A Type 1 manipulator requires only one step to complete the operation. A Type 2 manipulator requires multiple steps to complete the operation.

The term “viewer” is used throughout this specification to refer to a display area where the digital image being edited is presented. The viewer displays the digital image in its current state as well as additional UI elements as they are needed (e.g. manipulator visual component).

The term “thumbnail” is used throughout this specification to refer to a very small low-resolution representation of the users content: a photo or composition created from a photo.

The term “list” is used throughout this specification to refer to a set of multiple thumbnails used for navigating and selecting content from inventory. It has two states, a single column of thumbnails and an expanded list, which contains multiple columns of thumbnails.

The term “room” is used throughout this specification to refer to a collection of UI elements that when combined provide access to a set of related functions.

The term “tool” is used throughout this specification to refer to a UI element that initiates a command that affects the current image content in a pre-determined manner and that requires no additional user supplied input.

The term “menu” is used throughout this specification to refer to an option that initiates a room transition such that a new room, heretofore defined by the menu, replaces the current room.

Recently developed image manipulation programs, such as Adobe Photoshop™, provide the capability of using personal computers to alter digitally encoded photographs in ways heretofore only possible by professional photographers using expensive and time consuming techniques. Although quite amenable to being used on those monitors coupled to the personal computer, these programs have not been able to make the transition to standard TV displays for many reasons. One such reason is the inability to provide an easy to use navigation tool since most TVs have a standard remote control as the only input device capable of acting as the navigation tool. Unlike mice and trackballs, standard TV remotes typically have a limited number of inputs (up, down, right, and left, for example) that are readily amenable to directing a cursor on the TV display. In addition to the lack of an efficient navigation tool, traditional approaches to displaying graphical user interface elements (also referred to as icons) include overlaying the opaque icon image on top of the standard video broadcast signal. In this way, the icon totally blocks the incoming video signal over which it is laid thereby completely blocking the corresponding displayed image.

When using an image manipulation program such as Adobe Photoshop or Adobe PhotoDeluxe, the photograph being edited is displayed on only a portion of the available TV display thereby limiting the resolution of the displayed image. In addition to the inherently low resolution available on standard TV displays, the permanent blocking of those portions of the displayed photograph by other windows containing UI elements required by the program can be at best annoying and at worst unacceptable to the point of not being able to use the TV display.

In addition, navigating between the various icons and associated menu and information bars is burdensome and confusing since the TV remote control can only provide simple input directions (up, down, right, left, etc), which must be followed in a pre-determined manner. Therefore, in order to compensate for such limited input devices, an even simpler user model has been developed by the invention.

Broadly speaking, the invention relates to an improved method, apparatus and system that defines a new paradigm of an interactive TV application where user interface objects are layered over real-time user defined content (such as video or photos) allowing the user to interact with the application using a standard remote control. In this way, the user is afforded a consistent broadcast TV-like experience which has the capability of, for example, showcasing the user's photos or other content using substantially all available real estate on the TV screen. Furthermore, in contrast to conventional techniques that provide ornamental information by simply layering them on top of a predefined background or a standard video feed, the described embodiments interact with the user's content in real-time allowing them to manipulate selected photos, for example, in a living room environment or its equivalent.

In a particular implementation, a top area of a screen includes an information section, whereas a top-right corner portion of the screen includes a reference thumbnail as well as a list of photos, for example. This list of photos can be expanded downwardly, for example, in such a manner so as to overlay the right area of the screen, if so desired. A bottom portion of the screen includes an array of options that are related to whatever the current activity a user is currently engaged. In the described embodiments, each of these areas is overlaid on top of the background that typically includes the working image. It should be noted, any UI control active and shown on the screen can immediately interact with the user and their content in real-time.

Depending on the control, a specific UI element may be opaque (covering the background) or may be alpha blended with the background content. For instance, the thumbnails (small reference images) displayed in the list or expanded list are generally opaque and obscure the background. The primary reason is that the focus is on the thumbnails and not the background since the user is in the process of choosing another photo from the list or expanded list. However, most UI elements are semi-transparent and alpha-blended with the background content. This juxtaposition of opaque and semi-transparent and alpha-blended UI elements allows the user to focus on the content as opposed to the UI elements themselves. Further, it allows the application to maximize the screen real estate for the background content and thus not have a “port hole effect” as found with typical PC applications.

As discussed above, the displayed image is formed of a number of pixels and as is well known in the art, the number of bits used to define a pixel's color shade is referred to as its bit-depth. Bit depth can vary according to the capability of the display, the bit-depth of the original source image, as well as as well as the processing capability of the associated image processor in that the more bits associated with each pixel, the more computations required to render a particular image. One such color scheme has a bit depth of 24 bits (8 bits each for Red, Green, and Blue components in an RGB color space rendering) corresponding to what is referred to as “True color” (also sometimes known as 24-bit color). Recently developed color display systems offer a 32-bit color mode—three 8-bit channels for Red, Green, and Blue (RGB), and one 8-bit alpha channel that is used for control and special effects information such as for transparency information. As is well known in the art, the alpha channel is really a mask—it specifies how the pixel's colors should be merged with another pixel when the two are overlaid, one on top of the other. In this way, the alpha channel controls the way in which other graphics information is displayed, such as levels of transparency or opacity in what is referred to as alpha blending. In the described embodiment, alpha blending is the name for controlling the transparency or opacity of a displayed graphics image. Alpha blending can be used to simulate effects such as placing a piece of glass in front of an object so that the object is completely visible behind the glass, unviewable, or something in between.

In this way, alpha-blending provides a mechanism for drawing semi-transparent surfaces. With alpha-blending enabled, pixel colors in the frame buffer can be blended in varying proportion with the color of the graphics primitive being drawn. The proportion is referred to as the “transparency” or alpha value.

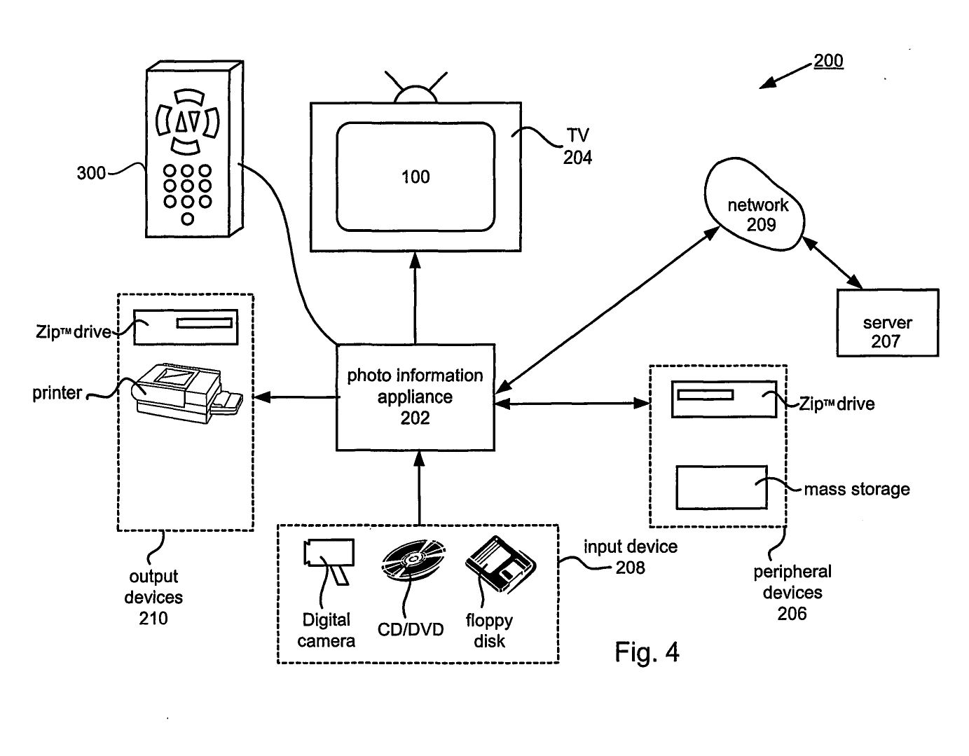

Referring now to FIG. 4, a block diagram of a TV system 200 arranged to process images displayed thereon in accordance with an embodiment of the invention is shown. The system 200 includes a photo information appliance 202 coupled to a standard TV receiver unit 204 capable of displaying the TV picture 100. The photo information appliance 202 is also coupled to a peripheral device 206 capable of storing a number of high-resolution images. The peripheral device 206 can take any number of forms of mass storage, such as a Zip™ drive, or any type of a mass storage device capable of storing a large quantity of data in the form of digital images. In some embodiments, the peripheral device 206 can be a non-local peripheral device such as can be found in a server-type computer system 207 connected to the photo information appliance 202 by way of a network 209 such as a local area network (LAN), Ethernet, the Internet, and the like. In this way, the images to be processed by the photo information appliance 202 can be stored and accessed in any location and in any form deemed appropriate.

An input device 208 coupled to the photo information appliance 202 provides either high resolution or low resolution digital images, which ever is required, directly to the photo information appliance 202. Such input devices can include digital cameras, CD/DVDs, scanners, video devices, ROM, or R/W CD as well as conventional floppy discs, SmartMedia, CompactFlash, MemoryStick, etc or connected via USB, 1394 (Firewire), or other communication protocol. It is one of the advantages of the invention that any number and type of input device, either digital or analog (with the appropriate analog to digital conversion) can be used to supply the digital images to the photo information appliance 202.

In this way, the input device 208 can be any device capable of providing a video signal, either digital or analog. In the described embodiment, as a digital video input device 208, a digital video signal is provided having any number and type of other well-known formats, such as BNC composite, serial digital, parallel digital, RGB, or consumer digital video. As well known in the art, the digital video signal can be any number and type of other well-known digital formats such as, SMPTE 274M-1995 (1920×1080 resolution, progressive or interlaced scan), SMPTE 296M-1997 (1280×720 resolution, progressive scan), as well as standard 480 progressive scan video.

In the described embodiment, the input device 208 can also provide an analog signal derived from, for example, an analog television, still camera, analog VCR, DVD player, camcorder, laser disk player, TV tuner, set-top box (with satellite DSS or cable signal) and the like. In the case where the input device 208 provides an analog image signal, the image processor includes an analog-to-digital converter (A/D) arranged to convert an analog voltage or current signal into a discrete series of digitally encoded numbers (signal) forming in the process an appropriate digital image data word suitable for digital processing.

When the photo information appliance 202 has substantially completed the processing of the digital image supplied by the input device 208, the processed image can be output to any number and type of output devices, such as for example, a laser printer, Zip drive, CD, DVD, the Web, email and the like. The system 200 can be used in many ways, not the least of which is providing a platform for real time editing and manipulation of digital images, which can take the form of digital still images or digital video images, depending on the input device 208 connected to the photo information appliance 202. As an example, assuming that a commercially available digital still camera, such as Nikon Coolpix 950 and Canon Powershot S10 have been used to take a number of photographs, some of which are to viewed as the TV picture 100 displayed on the TV receiver 204. Typically, the digital images taken by the digital camera 208 are stored in an in-camera cache type memory that typically takes the form of a SmartCard™ or other similar memory devices capable of storing any number of images of varying resolutions. Typically, the resolution of the stored images can range from a high resolution image (such as 1600×1200) or as a lower resolution image (such as 640×480). It is one of the advantages of the invention that the photo information appliance 202 is capable of processing a high resolution version while displaying a lower resolution image as the TV picture 100.

As discussed above, however, the available resolution of the standard TV picture 100 is substantially less than even the lowest resolution available on even the least sophisticated digital camera. It is for this reason that when the photo information appliance 202 identifies that the digital camera 208 is coupled thereto, the received image can be decimated (i.e., systematically reduced in resolution) in order to more effectively transmit, process, and display on the TV 204. It is at this time that a determination is made whether or not the original high-resolution image is to be retained. If retained, the high-resolution image is ultimately passed to the peripheral storage device 206 that is coupled to the photo information appliance 202. In some cases, the peripheral storage device 206 can be a local hard drive as part of a desktop computer or set top box arrangement, or it can be a non-local hard drive incorporated into a mass storage device incorporated into the server computer 207 coupled to the photo information appliance 202 by way of a network 209. By allowing the storage and retrieval of images in non-local resources, the ability to process any digital image in any location is possible.

Once a low-resolution version of the high-resolution digital image received from the digital camera 208 has been formed by the photo information appliance 202, it is passed to the TV 204 to be displayed as the TV picture 100. In a preferred embodiment, the displayed image is broadcast in a full screen format where substantially all available display capabilities of the TV picture 100 are utilized. This ability to use a full screen display substantially increases the useable work area available to the user.

In addition to the fill screen display of the low-resolution image, the photo information appliance 202 generates a thumbnail image (well know to those skilled in the art), which can also be displayed in conjunction with the corresponding fill screen displayed image. In the described embodiment, the thumbnail image provides a reference image corresponding to the digital image as originally received by the photo information appliance 202 and stored in the digital camera 208. In this way, the user is able to continually compare the most current version of the displayed image against the last saved version thereby providing a point of comparison and continuous feedback.

It should be noted, however, that the high-resolution images could still be used for image processing operations even for those filters that are resolution dependent. Furthermore, the high-resolution image can be used when rendering needs to occur when the output device has a resolution higher than standard NTSC TV display (i.e., HDTV display, printers, etc.). In general, images of intermediate resolution are typically created by a catalog core unit discussed below.

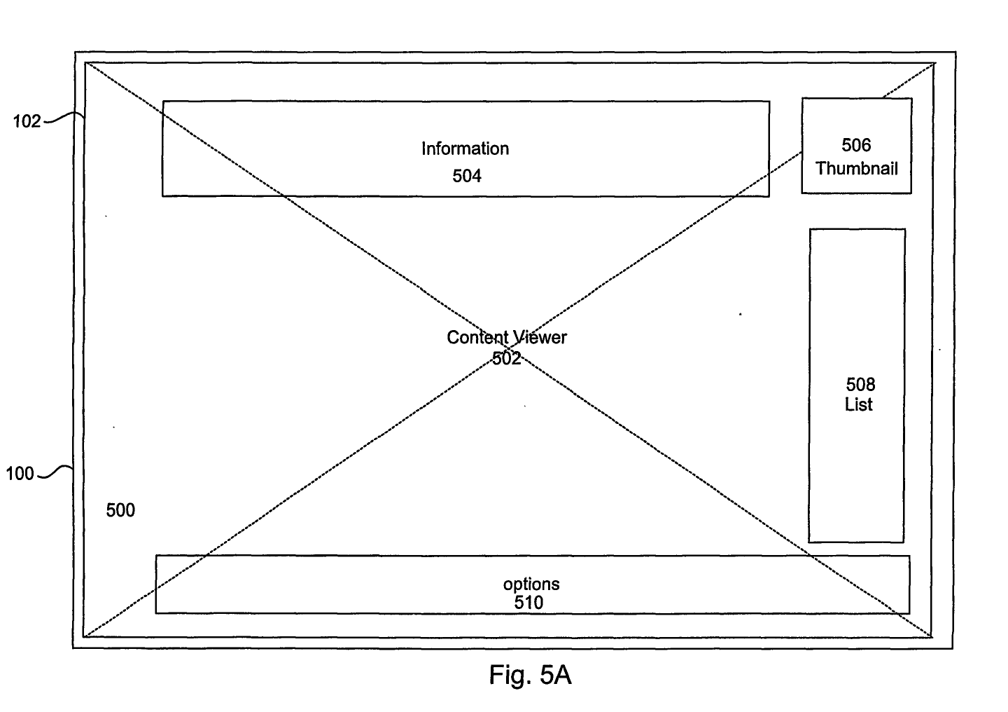

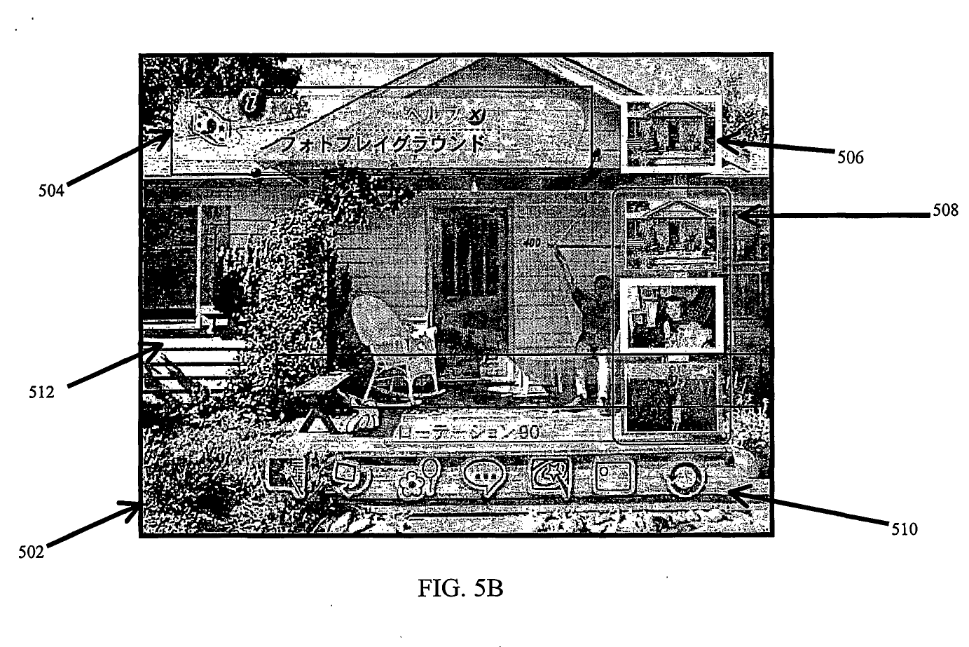

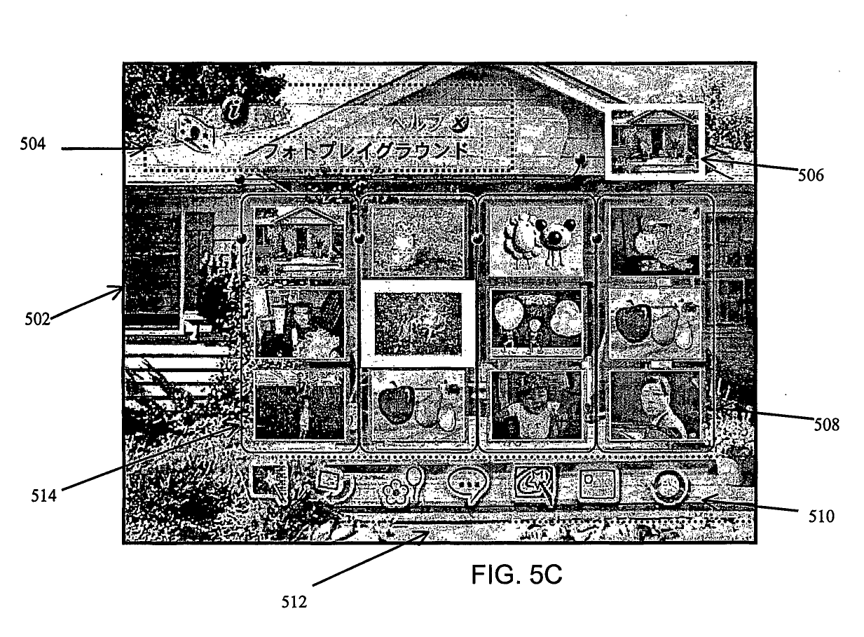

FIG. 5A illustrates the digital imaging application screen 500 generated by the photo information appliance 202 in accordance with an embodiment of the invention. It should be noted that the digital imaging application screen 500 is displayed in a full screen mode such that the entire active picture region 102 is used. Typically, the digital imaging application screen 500 is capable of displaying an image stored in any one of the available input devices that are coupled to the photo information appliance 202. As part of the image editing process, various menu and information bars are overlaid on the digital imaging application screen 500 in order to provide the user with the capability of rendering selected and desired effects in real time. Such effects include cropping, enlarging, shrinking, color correction, as well as any number of other operations consistent with the specific image editing software, such as generating greeting cards and calendars.

In the described embodiment, the digital imaging application screen 500 is broken up into four main areas overlaid on a content viewer 502. As illustrated in FIG. 5A, the overlays include an information area 504 that can contain any information that is useful to the user in a given application context. Typically, it is used to display such information as: current progress, application related icons, text relating to the current activity, help messages and/or any other appropriate prompt. In the top-right corner of the content viewer 502 is located a reference thumbnail 506. The reference thumbnail 506 displays the current image being displayed by the content viewer 502 out of a list of possible thumbnails that can be viewed by activating a list 508. Located in a bottom portion of the content viewer 502 is an options area 510 that, in the described embodiment, includes a set of available options. Typically, these options depend upon the current activity in which the user is presently engaged.

In a preferred embodiment, each of these four areas is placed on top of the background image that contains the user's current working image in the content viewer 502. UI elements that react to user inputs originating from the remote control 300 are referred to as active controls. However, there are other UI elements, such as those included in the information area 504 as well as the reference thumbnail 506, are not controlled directly by the user and are typically subject to being changed by the system itself, if needed.

FIG. 5B is an exemplary working image 512 displayed on the content viewer 502 in accordance with an embodiment of the invention. As can be readily seen and appreciated, the working image 512 covers the entire background of the content viewer 502 thereby affording the user a full screen mode image viewing experience. In the described embodiment, a user initiated event (such as clicking the DOWN button 304 on the remote control 300) has caused the list 508 to expand down out of the reference thumbnail 506, covering a right portion of the working image 512. It should be noted that another user initiated event (such as clicking the LEFT button 308 on the remote control 300) can, in turn, cause the list 508 to be expanded to the left, for example, into an expanded list of thumbnails referred to as a grid 514 as illustrated in FIG. 5C.

Referring back to FIG. 5B, depending on its function and/or purpose, a particular UI element may be opaque (covering the background) or may be alpha blended with the background content. For instance, the thumbnail images displayed in the list 508 are opaque and obscure the background. This is done to facilitate the task of choosing a new photo from the list 508 thereby allowing the user to focus on that task rather than the background image since blending of the background with the thumbnails would be too confusing. However, most other UI elements are semi-transparent (such as those found in the options area 510) and alpha-blended with the background content in a manner described below. In this way, the semi-transparent and alpha-blended UI elements do not block that portion of the displayed working image 512 on which it is overlaid. This allows the user to concentrate on the image content instead of the actual UI elements themselves. Furthermore, it allows the application to maximize the screen real estate for the background content and thus not have a “port hole effect” as found with conventional PC applications.

Another technique used to facilitate understanding of the application is the treatment of a control having what is referred to as focus and/or highlighting. In a typical implementation of the invention, since most UI elements are blended with the user's displayed content, it is important to provide aids to help the user understand what to do at any given time. This can be done with a technique referred to as highlighting. For example, a highlighting rectangle 516 surrounding the current thumbnail 506 as well as a highlighting rectangle 518 in the list 508 provides added visibility to a selected image 520. In those cases where editing tools (i.e., icons) are displayed within the options area 510, any selected tool is highlighted while unselected tools are not highlighted. In one embodiment of the invention, the highlighting takes the form of a hand pointing to the selected tool. In this way, the selected tool stands out from the background presented by the options area 510 as well as being easily distinguished from those unselected tools in the options area 510.

In one embodiment of the invention, the icons included in the options area 510 are animated such that when first presented on the digital imaging application screen 500, the animated icons associated with the options area 510 move, or apparently move, in one case, from the leftmost portion of the digital imaging application screen 500 to a position centrally located within the options area 510. Also, in one embodiment of the invention, the hand pointing to the selected option moves slowly up and down to aid in recognizing which option is selected.

Still referring to FIG. 5B, the exemplary information/guide area 504 shown is semi-transparent to approximately the same degree as the options area 510. The information/guide area 504 presents information relevant to the current state of the editing process such as, for example, which photo of a total number of photos available to the photo information appliance 202 is currently being displayed. By way of example, if there are a total of 25 photos stored in, or available to, the photo information appliance 202 and if the tenth photo of the 25 stored photos is currently being displayed, then an indicator such as, for example, “10/25” is displayed within the information/guide area 504. Other information available to be displayed in the information/guide area 504 includes those relevant to the current operation as part of a guided activity. It should be noted that a guided activity is one in which the user is directed in a stepwise fashion how to accomplish a particular task. Such guided activities include forming framed snapshots, calendars, greeting cards, as well as more complex editing activities related to, for example, creating special effects such as solarization. Therefore, the information/guide bar 504 is then capable of displaying, in any number of ways, a particular current step in the designated process and its relation to completing the selected process, as well as showing the current source icon, such as a digital camera, VCR, etc., and presenting the name or title of the particular image being edited.

In a preferred embodiment of the invention, the reference thumbnail image 506 is opaque in contrast to the semi-transparent and alpha blended options area 510 and the information/guide bar 504. The reference thumbnail image 506 provides a reference point for the user to compare during the editing process such that the user can continuously track the changes being made to the working image 512 and whether or those changes are for the better, in a subjective sense. The list 508 (also opaque) is provided that shows, in any number of ways, the images that are available for display and eventual editing. These images are typically thumbnail images stored in the photo information appliance 202 and as such are relatively easy to create, download and display as needed.

Once a photo has been selected, it is displayed in the full screen content viewer on the television display. The system can either be in “navigational” mode or “manipulation” mode. In navigational mode, the LEFT/RIGHT buttons of a standard remote control, for example, allow the user to navigate between the different options along the bottom of the screen. The GO (ENTER) button activates the selected option. This in turn may 1) replace the options with another set of options, 2) activate a manipulator or 3) perform a modeless tool action. When a manipulator is activated, the system enters manipulation mode enabling the user to perform some editing operation on the displayed working image 512. If the user presses GO (ENTER), the manipulator is deactivated and the operation is accepted and applied to the photo. If the user presses BACK (CANCEL), the manipulator is deactivated and working image 512 is restored to its previous (unedited) state. While a manipulator is active, all remote control inputs apply to that particular manipulator. Once the manipulator is deactivated (by pressing CANCEL or ENTER, for example) remote control actions are once again navigational in nature. (Manipulators will be discussed in more detail below.)

In the described embodiment while in navigational mode, UP/DOWN activates the list 508 causing it to slide on screen from the reference thumbnail Once activated the UP/DOWN buttons allow the user to scroll up and down in the list of photos. To choose the current photo, the user presses GO, deactivating the list 508 causing it to slide off screen, replacing the full screen photo with the one chosen. BACK also deactivates the list 508 leaving the current photo unchanged. When the list 508 is active, LEFT and RIGHT no longer navigate between the options along the bottom of the screen, but instead expand the list to the grid 514. Once the grid 514 is active, the UP/DOWN/LEFT/RIGHT buttons control navigation only within the grid 514. If the user presses BACK, the grid 514 is deactivated and slides off screen. If the user presses GO, the grid is deactivated and the full screen photo is replaced with the new selection. This activation and deactivation of controls has the advantage of allowing the same buttons on the remote control to be used for different purposes depending on the control that currently has the focus.

In order to facilitate navigation between the various icons included in the options area 510, the information/guide area 504, and the list 508, the photo information appliance 202 has the ability for a UI element to turn focus on and off to highlight particular areas of interest. By focus on, it is meant that the focused area is active and that any icon included therein can be accessed and caused to be highlighted. It is a particular advantage of the invention that those areas that are unfocused (and therefore not active) can be bypassed thereby avoiding the unnecessary user input events (such as clicking up, down, etc on the remote control 300) as is typical with the conventional approaches to the displaying of and navigating through the UI elements on the TV 204.

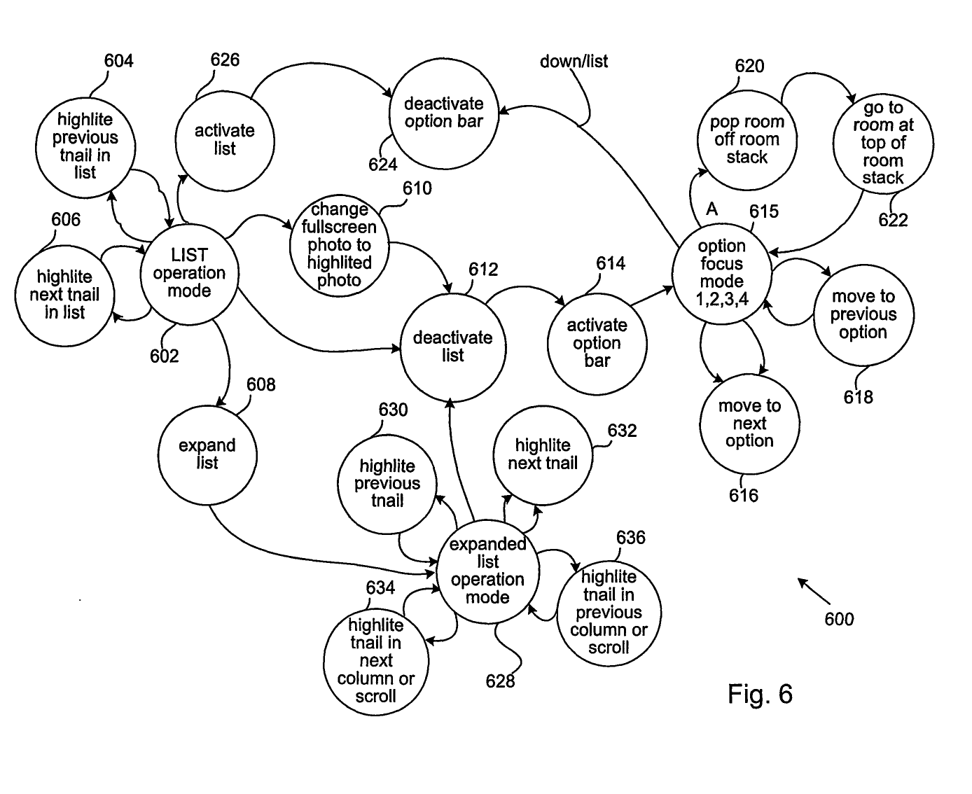

FIG. 6 illustrates an option bar and list state diagram 600 in accordance with an embodiment of the invention. It should be noted that user input events described with reference to FIG. 6 are purely arbitrary and can in fact be any appropriate user input as may be required. With this in mind, in a List Operation Mode at 602, an UP event highlights a previous thumbnail in the list at 604 whereas a DOWN event highlights a next thumbnail in the list at 606. In the described embodiment, a LEFT event expands the list to form a grid of multiple columns at 608.

A GO event changes the image displayed in the content viewer to the highlighted current thumbnail at 610 substantially simultaneously with deactivating the list at 612 and activating the option bar at 614. Once the option bar is active, the option focus mode is enabled at 615. In the described embodiment, the option focus mode is responsive to a RIGHT event, a LEFT event, a BACK event, or a DOWN event. When a RIGHT event is provided, the next option UI element is placed in focus at 616 whereas when a LEFT event is provided, the previous option is placed in focus at 618. In those cases where a BACK event is provided, the current room is popped off the room stack at 620 and the new current room at the top of the stack is in focus at 622. When a DOWN event is provided, the option bar is deactivated at 624 and the List is re-activated at 626 with the current thumbnail highlighted.

Returning to the expanded list operation mode at 608, the expanded list operation mode at 628 is responsive to an UP event, a RIGHT event, a LEFT event, a DOWN event, and a BACK/LIST event. When an UP event is provided, then the previous thumbnail is highlighted at 630 whereas when a DOWN event is provided, the next thumbnail is highlighted at 632. In those cases where a RIGHT event is provided, a thumbnail in the next column is highlighted or scrolled at 634 whereas when a LEFT event is provided the previous column is highlighted or scrolled at 636. In those cases where a BACK/LIST event is provided, control is passed to 612 where the List is deactivated.

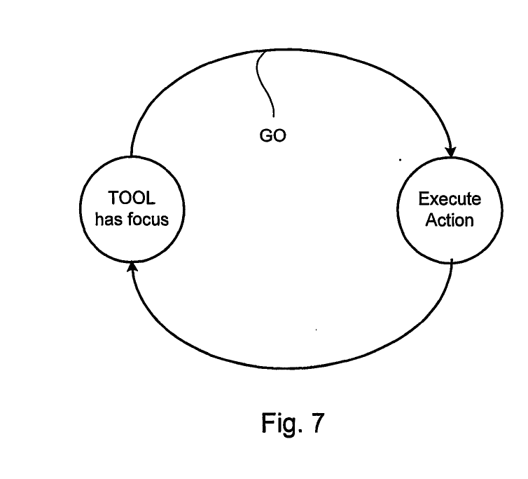

Referring to FIG. 7, a tool state diagram 700 in accordance with an embodiment of the invention is shown. It should be noted that user input events described with reference to FIG. 7 are purely arbitrary and can in fact be any appropriate user input as may be required. In those situations where a particular tool has focus at 702, a GO event executes the action associated with the particular tool in focus at 704. Such actions include, but are not limited to, instant fix, rotate, red eye correction, and the like. For example, if an instant fix tool is in focus, a GO event will cause the instant fix algorithm to activate without any further user input events required.

As defined above, a Type 1 manipulator requires only one step to complete the associated operation whereas a Type 2 manipulator requires multiple steps to complete the associated operation. One example of a Type 2 manipulator is the SRT (scale/rotate/translate) manipulator. In the case of the SRT manipulator, in the first step, the list is expanded in order for the user to select the content (clipart) that is to be added to the current image. In the second step, the selected clipart can be scaled, rotated and translated as desired.

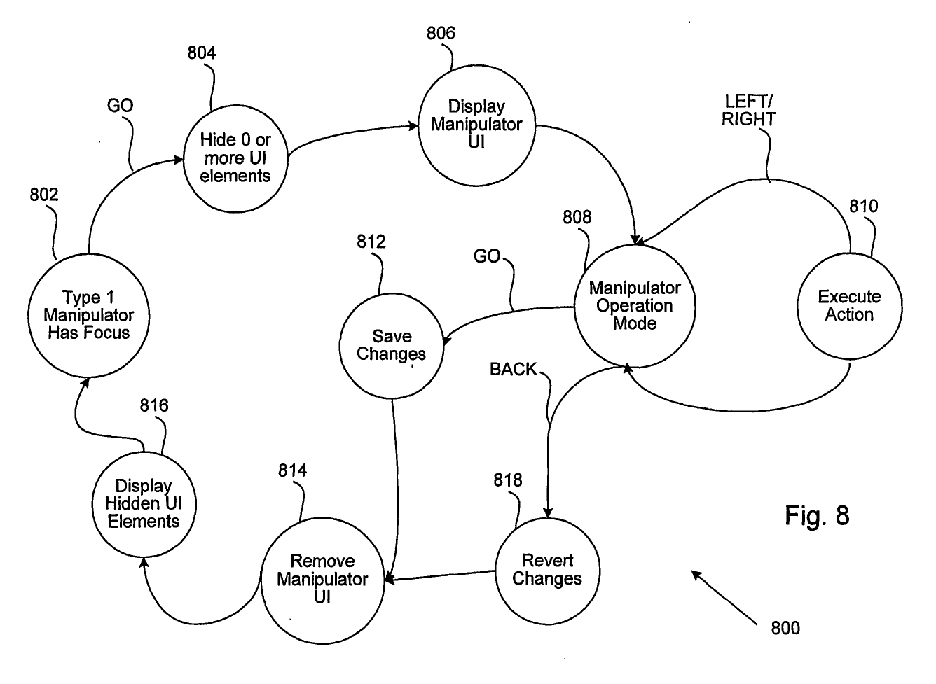

FIG. 8 illustrates a type 1 manipulator state diagram 800 in accordance with an embodiment of the invention. It should be noted that user input events described with reference to FIG. 8 are purely arbitrary and can in fact be any appropriate user input event as may be required or desired. A typical type 1 manipulator would be a slider type manipulator described above. At 802, the type 1 manipulator has focus thereby being responsive, in the described embodiment, to a GO event only. When a GO event is provided by the user, a pre-selected number of UI elements are hidden at 804. At 806, the manipulator UI is displayed (which in the case of the slider manipulator the manipulator UI is the slider icon). Display of the manipulator UI in turn provides a user interface for user to provide inputs consistent with the type 1 manipulator operation mode at 808. In the described embodiment, the type 1 manipulator operation mode is responsive to a GO event, a BACK event, and a LEFT/RIGHT event. In the case of a LEFT/RIGHT event, the action associated with the type 1 manipulator is executed at 810. Whereas, in the case of a GO event, the changes (if any) are saved at 812 and the manipulator UI is removed at 814 and the heretofore hidden UI elements are now displayed at 816.

Returning to 808, a BACK operation reverts the image to the previous state (i.e., does not apply and/or save any changes) at 818 and control is passed to 814.

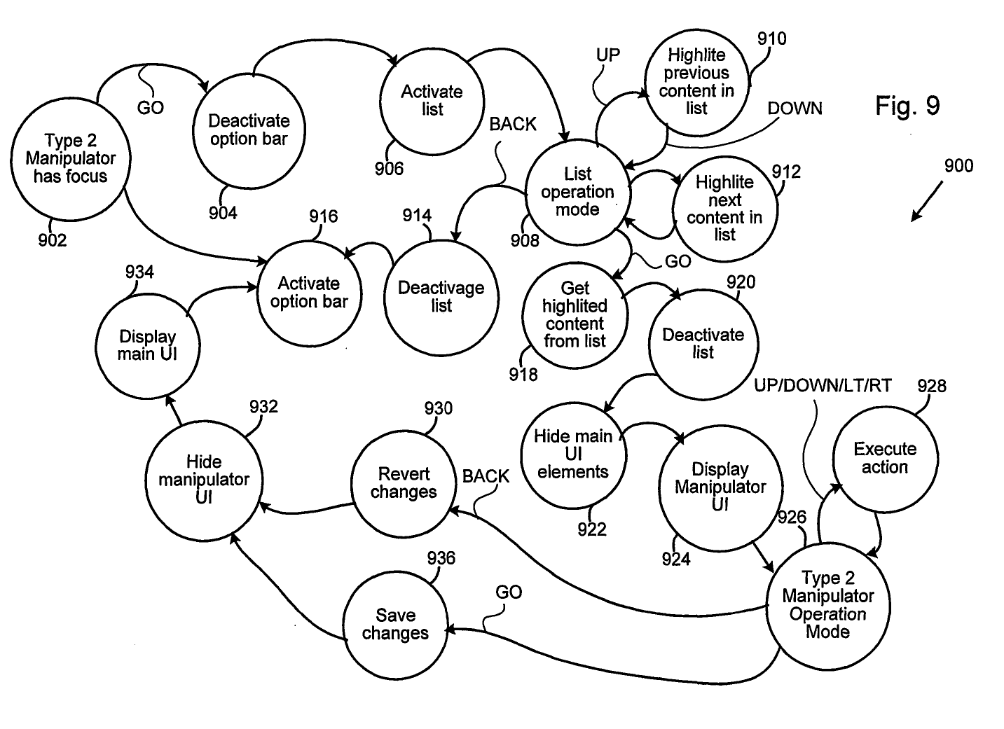

FIG. 9 illustrates a type 2 manipulator state diagram 900 in accordance with an embodiment of the invention. It should be noted that user input events described with reference to FIG. 9 are purely arbitrary and can in fact be any appropriate user input event as may be required or desired. At 902, the type 2 manipulator has focus thereby being responsive, in the described embodiment, to a GO event only. When a GO event is provided, the option bar is deactivated at 904 substantially simultaneously with activating the list at 906 thereby enabling the list operation mode at 908. In the described embodiment, the list operation mode is responsive to an UP event, a BACK event, a GO event, and a DOWN event. In the case of an UP event, the previous content in the list is highlighted at 910 whereas a DOWN event highlights the next content in the list at 912. In the case of a BACK event, the list is deactivated at 914 substantially simultaneously with activating the option bar at 916.

Returning to the list operation mode at 908, in the case of a GO event, the highlighted content from the list is fetched at 918 substantially simultaneously with deactivating the list at 920. The main UI elements are hidden at 922 substantially simultaneously with displaying the type 2 manipulator UI element at 924 thereby providing an interface between the user and the type 2 manipulator operation mode at 926. In the described embodiment, the type 2 manipulator operation mode is responsive to UP, DOWN, LEFT, RIGHT, and any positional type event by executing the action associated with the type 2 manipulator operational mode at 928. In the case where a BACK event is provided at 926, the changes made to the working image (if any) are reverted (i.e., not saved) at 930 and the type 2 manipulator UI element is hidden at 932 substantially simultaneously with displaying the main UI element at 934 concurrently with activating the option bar at 916.

Returning to the type 2 manipulator mode at 926, when a GO event is provided, the changes to the displayed working image (if any) are saved at 936 and the type 2 manipulator UI element is hidden at 932.

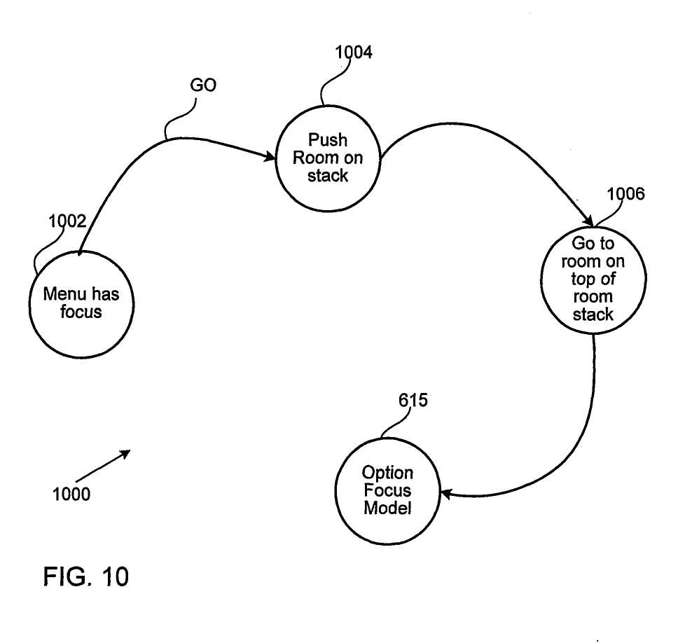

As defined above, a “menu” initiates a room transition such that a current room is replaced by a new room heretofore defined by the menu. Accordingly, FIG. 10 illustrates a menu state diagram 1000 in accordance with an embodiment of the invention. It should be noted that user input events described with reference to FIG. 10 are purely arbitrary and can in fact be any appropriate user input event as may be required or desired. At 1002, the menu has focus thereby being responsive, in the described embodiment, to a GO event only. When a GO event is provided, the current room is pushed off the room stack at 1004 and at 1006, the new current room is pushed to top of the stack. At this point, the user is then able to interact with the new current room by way of the option focus mode is enabled at 615.

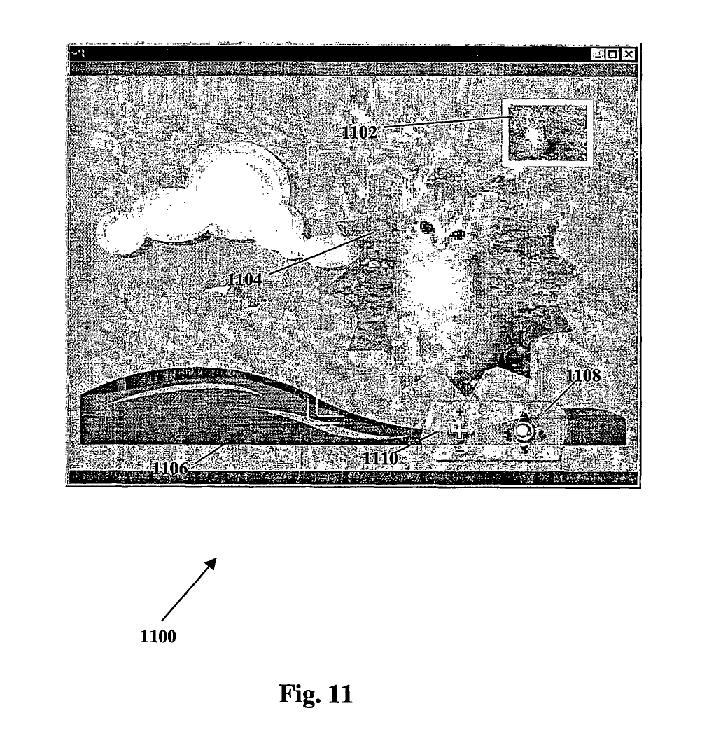

One of the advantages of the present invention is the capability of providing any number and type of manipulators some of which can provide very complex image editing that is very transparent to the user. In this way, the user can perform complex image manipulation algorithms in real time in a very transparent manner. One such manipulator is referred to as the reframe manipulator that combines the actions of panning and zooming into one easy to use tool. In the example shown in FIG. 11, once activated, the reframe manipulator UI 1100 shows the boundaries of a thumbnail photograph 1102 beneath the viewing hole 1104 of a card 1106. As illustrated, the reframe manipulator UI 1100 includes an integrally coupled panning tool 1108 and a zooming tool 1110. In this way, any of the remote control input buttons (304-308) are used to pan and zoom the photo. For example, using visual feedback, the UP/DOWN buttons can be used to increase and/or decrease the zoom factor of the photo. Additional buttons, joystick or dials on the remote can be used to move or pan the photo as desired.

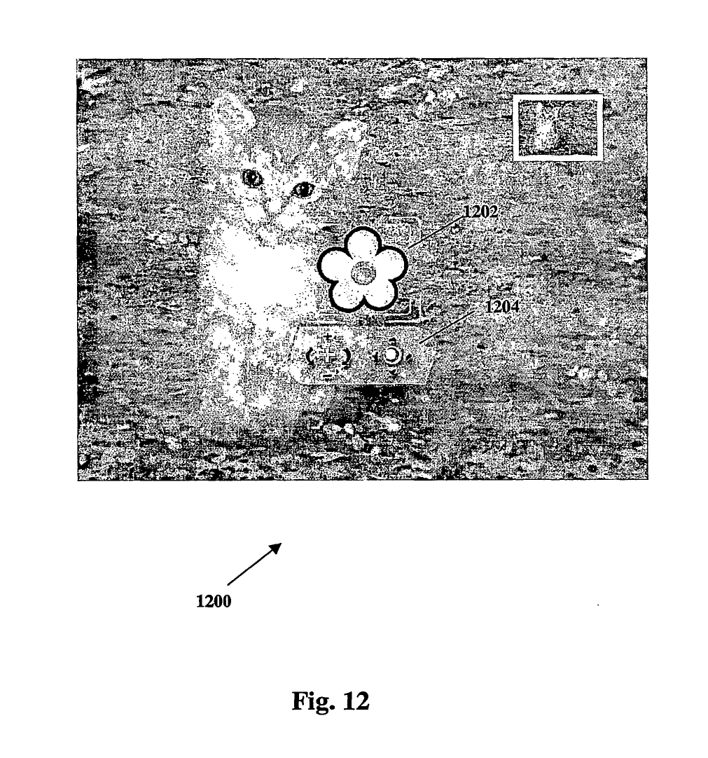

Another such manipulator is referred to as the scale, rotate, and translate (SRT) manipulator that combines the actions of panning and zooming into one easy to use tool. In the example shown in FIG. 12, illustrating how an SRT manipulator 1200 combines the actions of scale, rotate and translate of a selected clipart 1202 into one easy to use tool. The first step is to choose a piece of clipart. In the example shown in FIG. 12, once activated, the SRT UI shows the boundaries of the clipart 1202. Various remote control buttons can be used to scale, translate and rotate the clipart using an integrally coupled SRT interface 1204. In the described embodiment, based upon visual feedback, the SRT interface 1204 responds to UP/DOWN events by increasing and/or decreasing the size of the clipart 1202 whereas the SRT interface 1204 responds to LEFT/RIGHT events by rotating the clipart 1202. It should be noted that, any additional buttons, joystick or dials could be mapped to move the clipart 1202 around the screen as desired.

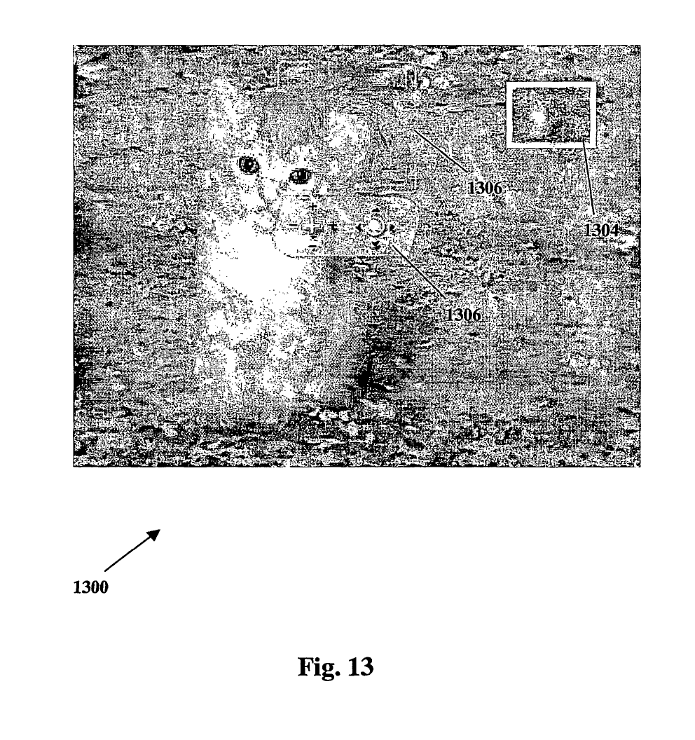

Another such manipulator referred to as a warp stamp manipulator that functions much as the SRT manipulator with one exception. Those functions do not change the actual pixels of the image but are simply added to the image in contrast to adding a piece of clipart or placing an image within a card or frame. In the example shown in FIG. 13, a warp stamp manipulator 1300 is used to apply a warp stamp filter 1302 to an image 1304 that has the effect of modifying certain of the pixels in the image 1304. A remote control, or any such device, can be used provide input events to a warp stamp interface 1306 to either move the warp stamp filter 1302 over the image 1304 and/or to increase and/or decrease the size of the warp stamp filter 1302. As these changes are being made, the warp stamp filter 1302 is continually updated showing the effect of the warp stamp filter 1302 on the image 1304.

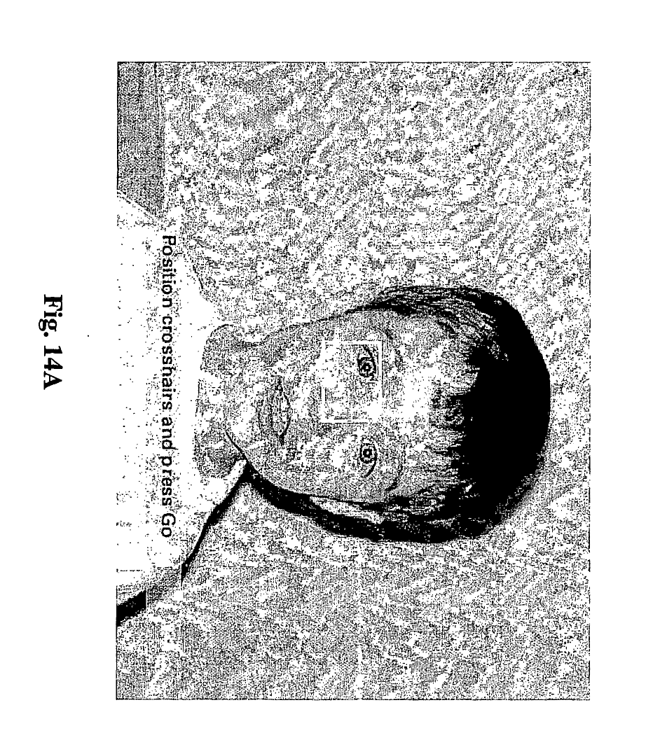

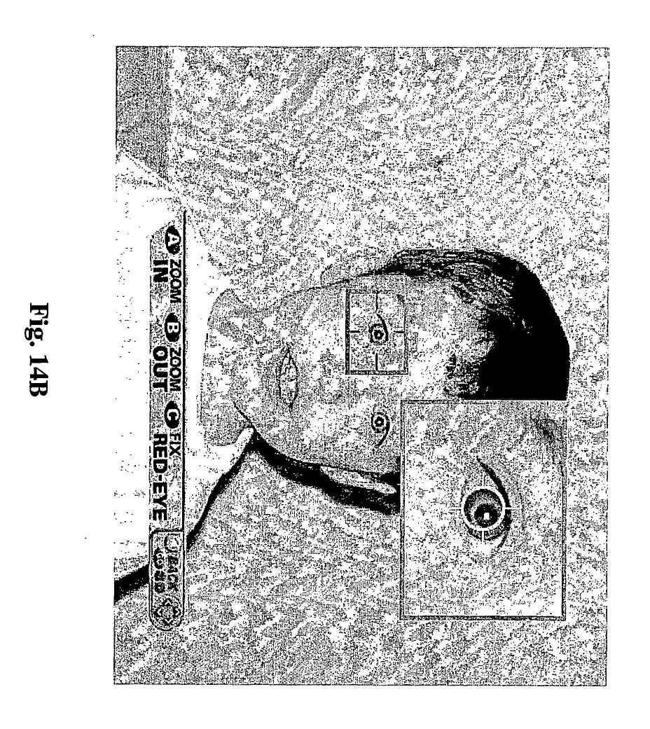

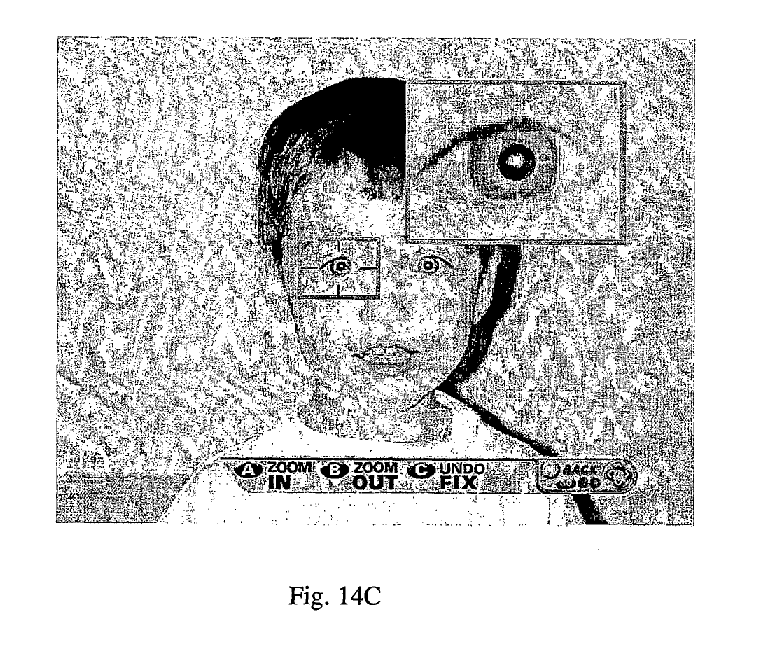

Yet another manipulator referred to as the remove red eye manipulator that allows the user to provide the additional input required to remove red eye from a photo. As illustrated in FIGS. 14A, 14B and 14C, the remove red eye manipulator UI guides the user to click on as many red eyes as are present in the current photo. It allows the user to move around the UI guide to identify the red eyes. In some embodiments, the UI guide can change its size and appearance to allow a larger region to be used for the red eye reduction. When complete the red eye(s) are removed and the user can either accept and save the changes or discard the changes to the photo.

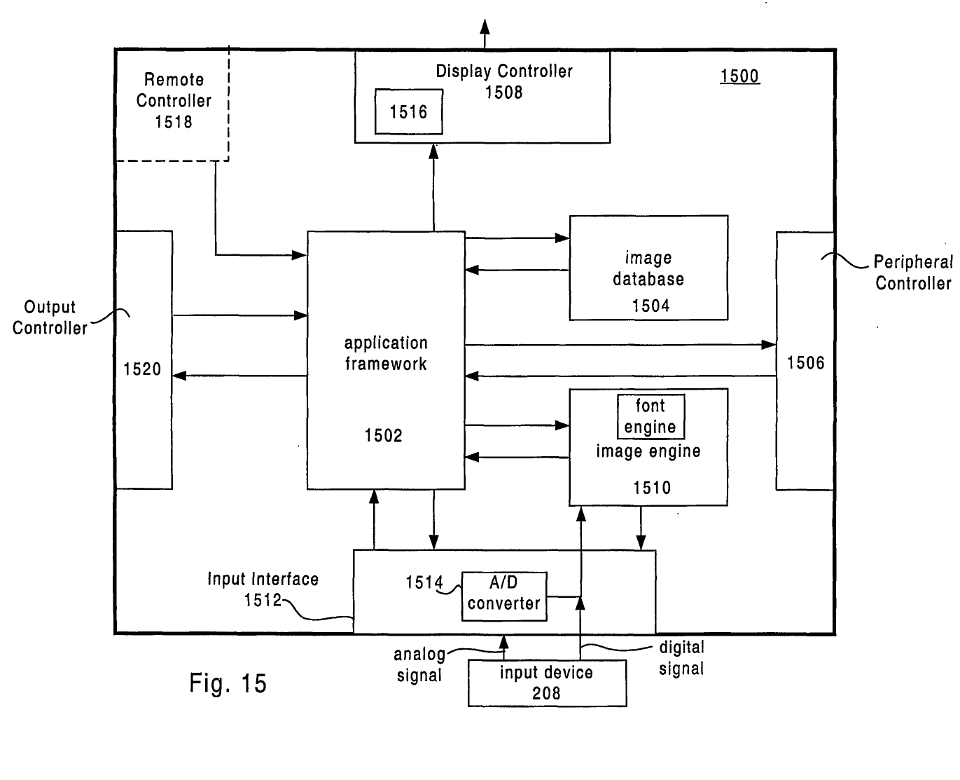

Referring now to FIG. 15 illustrating a functional block diagram of a particular implementation of the photo information appliance 202. In the described implementation, the photo information appliance 202 includes an application framework 1502 arranged to provide basic control functions for the photo information appliance 202. The application framework 1502 is coupled to an image database 1504 arranged to store the various representations of the images that are to be displayed by the TV 204 as directed by the application framework 1502. In some embodiments, the image database 1504 maintains an index of all images and associated editing operations in the form of meta-data. Typically, the storage capability of the image database 1504 is rather limited and as such only lower resolution and thumbnail versions of the high-resolution images provided by the input device 208 connected to the photo information appliance 202 are stored therein. In this way, the image database 1504 can be considered a memory cache that provides fast and efficient access to the images. If higher resolution images beyond those stored in the image database 1504 are to be used, then they are typically stored in any number or kind of mass storage devices that constitute the peripheral device 206 connected to the Application framework 1502 by way of a peripheral controller 1506. The peripheral controller 1506, as directed by the Application framework 1502, controls the flow of traffic between the peripheral device 206 and the Application framework 1502. In the case where the peripheral device 206 is coupled to the photo information appliance 202 by way of the network 207, then the peripheral controller 1506 can take the form a modem port, for example.

In the case where a high-resolution image is retrieved from the peripheral device 206, then the Application framework 1502 provides a read signal to the peripheral controller unit 1506, which, in turn, causes the selected high-resolution image to be retrieved from the appropriate mass storage device. Once retrieved, the Application framework 1502 directs the high-resolution image be output to and displayed by the TV 204 by way of a display controller 1508.

In the described embodiment, an image engine 1510, also known as image core, is coupled to the Application framework 1502 is arranged to provide the necessary image manipulation as required by the resident image manipulation software. The image engine 1510 is capable of, in some embodiments, decimating the retrieved image as directed by the Application framework 1502, which then directs the catalog core 1504 to store it. The image engine 1510 also generates the reference thumbnail 1508 which can also be stored in the catalog core 1504. The image engine 1510 is also responsible for font rasterization via its internal font engine. When directed by the Application framework 1502, both the low-resolution image and the associated reference thumbnail are displayed by the TV 204.

Another function of the image engine 1510 is to provide the transparent background used for the options area 510 as well as the information/guide area 504. In one embodiment of the invention, the image engine 1510 creates the transparent background using what is referred to as alpha blending.

An input interface 1512 coupled to the Application framework 1502 provides a conduit from the input device 208 to the imaging engine 1510. As directed by the Application framework 1502, the input interface 1512 retrieves an image provided by the input device 208 and processes it accordingly. As discussed above, the input device 208 can be either a digital or an analog type device. In the case of an analog type input device, an analog to digital converter 1514 is used to convert the received analog image to a digital image. It should be noted that any of a wide variety of A/D converters can be used. By way of example, other A/D converters include, for example those manufactured by: Philips, Texas Instrument, Analog Devices, Brooktree, and others.

When coupled to a remote control unit, such as the remote control 300, a remote controller 1518 couples the remote control unit 300 to the Application framework 1502. In this way, when a user provides the proper input signals by way of the remote control unit 300, the Application framework 1502 acts on these signals by generating the appropriate control signals. An output interface unit 1520 couples any of the output devices 210 to the Application framework 1502.

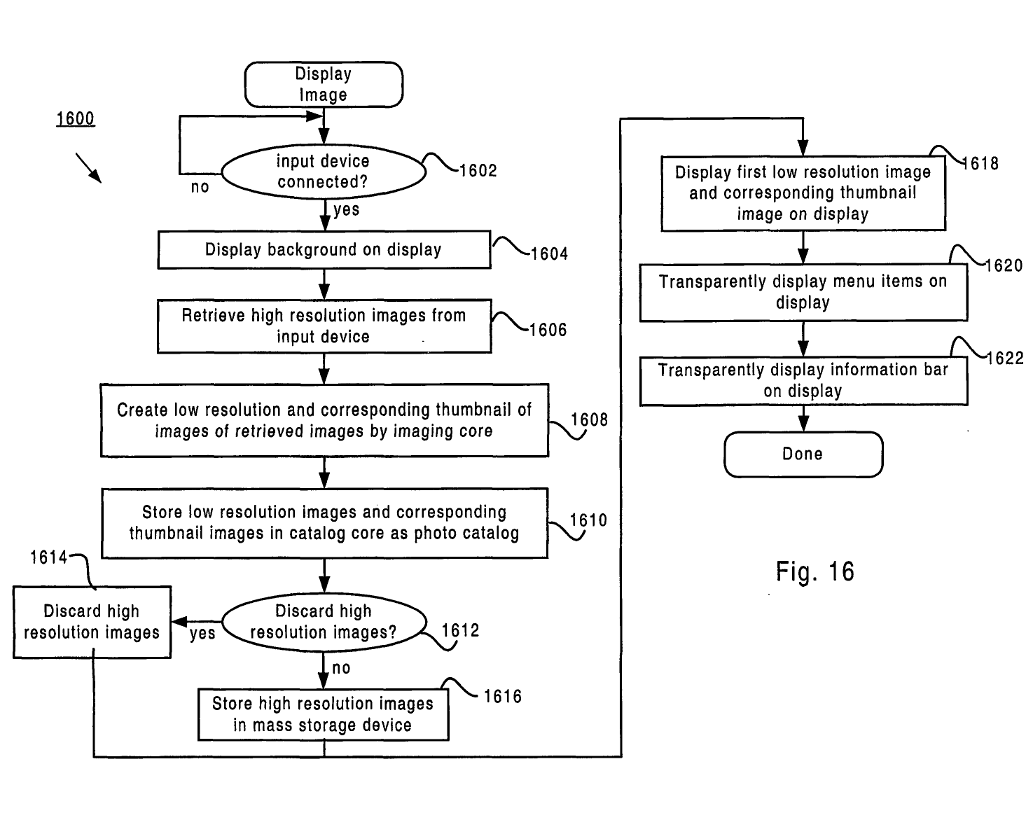

FIG. 16 is a flowchart detailing a process 1600 for displaying an image in accordance with an embodiment of the invention. The process 1600 begins at 1602 by the UI controller determining if there is an input device connected to the image processor. This determining is typically accomplished by a control signal from the input device to the UI controller unit indicating that a connection has been successful. Next, at 1604, a background image is displayed. In one embodiment, the background provides a border that highlights the image being displayed for editing purposes. In another embodiment, the background can be another image, which can be superimposed on another image subsequently displayed. At 1606, any high-resolution images are retrieved from the input device and at 1608, a corresponding low-resolution image and a reference thumbnail image are then created by, in one implementation, the image engine unit. At 1610, the low-resolution image and the thumbnail image are stored in the catalog core unit as directed by the UI controller. In one embodiment, the images stored in the catalog core unit take the form of a photo catalog.

Next, at 1612 a determination is made whether or not to discard the high-resolution images. If it is determined that the high resolution images are not to be maintained, then the high resolution images are discarded at 1614, otherwise, the high resolution images are stored in a mass storage device at 1616. In one embodiment of the invention, the mass storage device can take the form of a Zip drive incorporated into a set top box, for example. In other cases, the mass storage device can be a non-local mass storage device located in or coupled to a server type computer coupled to the image processor by way of a network, such as the Internet. At 1618, the first low-resolution image is displayed along with its corresponding reference thumbnail image. It should be noted, that the displayed images are not transparent and overlay the background such that only the image to be edited is visible over the already displayed background image.

At 1620, a variety of appropriate menu items are transparently displayed such that the underlying image to be edited is not blocked thereby substantially increasing the useable work area available to the user. At 1622, a variety of icons are transparently displayed as part of an information bar, which is also displayed in a transparent manner so as to not block the view of the image being displayed. It should be noted that the transparency of each displayed item could be different based upon each items particular alpha blending which depends, in part, on the portion of the image over which it will be displayed.

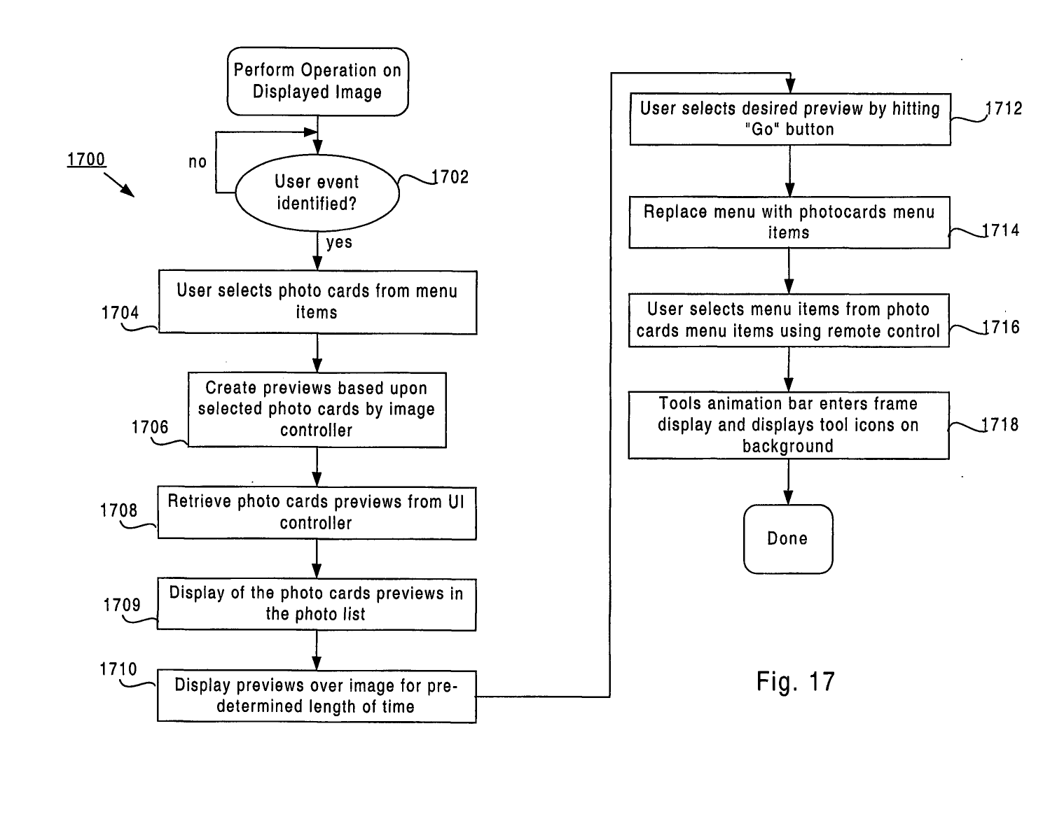

Once the image has been displayed along with the appropriately configured information and menu bars and associated icons, an operation is performed on the displayed image. Such operations can include any number of editing operations, such as cropping, rotating, inverting, etc. Along these lines, therefore, FIG. 17 details a process 1700 for performing an operation on the displayed image in accordance with an embodiment of the invention. It should be noted that for this example, the operation being performed is related to creating a photo card from one of a number of images stored in the catalog core and displayed on the photo list.

The process 1700 begins at 1702 by determining whether or not a user event has been identified. Such identifiable user events include, highlighting a particular option, such as one associated with cropping a portion of the displayed image. In this example, the user event has been identified at 1704 as the user selecting, a photo cards option from the option bar displayed on the working image. Once the user has selected the photo cards option, a series of previews based upon the available photo cards are created by the UI controller unit at 1706. Once the previews have been created by the UI controller, the photo cards previews are retrieved from the UI controller at 1708. These previews are displayed in the photo list at 1709. One of these selected photo cards is also composited with the working image. The user will then be able to navigate the list and preview how each card will look composited with the working image at 1710.

At any time that a particular card preview is being displayed, the user can select the particular preview be entering a user event, such as by pressing the “GO” button at 1712. Once the user has selected a particular card, the displayed menu is replaced with an appropriately configured photo cards menu at 1714. Once the user has selected a particular preview, the user selects additional menu items form the photo cards menu using the remote control unit coupled to the image processor at 1716. At 1718, a tool animation bar enters the frame display and displays various appropriate tool icons in the background.

This inventive interface allows the user to efficiently navigate the user interface and manipulate digital images using a remote control, without the use of a pointing device such as a mouse by directly interacting with the image content. This direct interaction is made possible by layering UI controls over the actual content via alpha blending. While the specific transparency aspect is not unique, its use in the user interface throughout the entire application makes it possible for the user to directly interact with full-screen content in real-time. The user interface may take advantage of a mouse in a more limited fashion. For instance, the user could use a mouse to move around a point (locator) on the screen to mark a red-eye that should have fixed. However, actual navigation through the interface will not directly use the pointing device. While this paper references a “remote control device”, any form of input devices (connected or remote) could be used to provide the primary form of navigation for this invention provided it is by discrete up/down/left/right sequences, opposed to a pointing device such as a mouse or trackball.

In this paradigm, the user interface objects are layered over the user's real-time defined content, such as video or photos. This provides a consistent TV-like experience and showcases the user's content utilizing all available real estate on the TV screen. Further it goes well beyond today's interactive TV applications of simply providing ornamental information that is simply layered on top of a predefined background or a standard video feed, but interacts with the user's real-time defined content.

This particular invention was originally developed for a digital imaging or digital video consumer electronic device connected to a television. However, its application can be applied to general interactive TV design, web based application and site design, as well as general computer applications, including games, displayed on a television or by any computing device. This invention should not be limited to strictly digital still and video imaging application and should include any interactive TV application since the techniques described here provide benefit to general applications as well.

While the present invention has been described as being used with a digital video system, it should be appreciated that the present invention may generally be implemented on any suitable system that permits the user to interact dynamically and change the content of the data, including still image or video data, that is being display. This includes both user-defined content and pre-rendered data. Therefore, the present examples are to be considered as illustrative and not restrictive, and the invention is not to be limited to the details given herein, but may be modified within the scope of the appended claims along with their full scope of equivalents.

What is claimed is:

In the claims:

1. A method for using a limited input device to navigate through a plurality of user interface (UI) control elements overlaying a video content field, comprising:
identifying a room, wherein the room is a specific set of the plurality of UI control elements that, taken together, allow a user to perform a related set of activities using the limited input control device;
moving between those of the plurality of UI control elements that form a first subset of the specific set of UI control elements that form the identified room using the limited input control device; and
executing a first action corresponding to a particular active UI control element of the first subset based upon an input event provided by the limited input device.

2. A method as recited in 1, further comprising:
activating other ones of the specific set of the UI control elements to form a second subset;
deactivating one of the first subset of UI control elements; and
executing a second action corresponding to a particular active UI control element of the second subset based upon an input event provided by the limited input device.

3. A method as recited in claim 2, wherein activating the second subset of the UI control elements substantially simultaneously de-activates the first subset of UI control elements.

4. A method as recited in claim 2, wherein activating the first subset of the UI control elements substantially simultaneously de-activates the second subset of UI control elements.

5. A method as recited in claim 2, wherein the second subset of UI control elements is activated by a single input event at any time.

6. A method as recited in claim 1, wherein the first subset is an option bar.

7. A method as recited in claim 2, wherein the second subset is a list, wherein the list is selected from the group comprising: a list and an expanded list.

8. A method as recited in claim 7, wherein the list is formed of a single column of cells and wherein the expanded list is formed of multiple columns of cells.

9. A method as recited in claim 8, wherein the action is selected from the group comprising: a menu, a tool, and a manipulator.

10. A method as recited in claim 18, wherein the menu initiates a room transition such that a current room is replaced by a new room that is defined by the menu.

11. A method as recited in claim 10, wherein the tool initiates a command that affects a current image in a pre-determined manner that requires no additional user supplied input.

12. A method as recited in claim 10, wherein the manipulator requires additional user supplied input to accomplish its designated function as well as initiates a command that affects the current content in a pre-determined manner that requires no additional user supplied input.

13. A method as recited in claim 12, wherein the user supplied input is received by leaving the navigation mode and entering the manipulator mode, wherein in the manipulator mode user content is dynamically updated as the user input is received and wherein in order to de-activate the manipulator, a single user supplied input event is used to either save or discard the changes made to the image content.

14. A method as recited in claim 13, wherein a first type manipulator requires a single additional user supplied input event to accomplish its designated function and wherein a second type manipulator requires more than the single additional user supplied input events to accomplish its designated function.

15. A method as recited in claim 11, wherein the image includes image data selected from a group comprising: image data supplied by a user, pre-rendered image data, predefined image data, image data not specifically supplied by the user.

16. A method as recited in claim 11, wherein the image is a pixel based digital image.

17. A method as recited in claim 11, wherein the image is a video image.

18. A method as recited in claim 1, wherein the limited input device is a non-pointing input device.

19. A method as recited in claim 14 wherein the first type manipulator is a slider.

20. A method as recited in claim 14 wherein the second type manipulator is selected from a group comprising: a scale, rotate, translate (SRT) manipulator, a red eye correction manipulator, and a reframe manipulator.

21. A computer-readable medium containing programming instructions for using a limited input device to navigate through a plurality of user interface (UI) control elements included in a video content field, the computer-readable medium comprising computer program code arranged to cause a host computer system to execute the operations of:
identifying a room, wherein the room is a specific set of the plurality of UI control elements that, taken together, allow a user to perform a related set of activities using the limited input control device;
moving between those of the plurality of UI control elements that form a first subset of the specific set of UI control elements that form the identified room using the limited input control device; and
executing a first action corresponding to a particular active UI control element of the first subset based upon an input event provided by the limited input device.

22. A computer-readable medium containing programming instructions for using a limited input device to navigate through a plurality of user interface (UI) control elements included in a video content field as recited in claim 21 the computer-readable medium comprising computer program code arranged to cause a host computer system to execute the additional operations of:
activating other ones of the specific set of the UI control elements to form a second subset;
deactivating one of the first subset of UI control elements; and
executing a second action corresponding to a particular active UI control element of the second subset based upon an input event provided by the limited input device.

23. A computer-readable medium containing programming instructions for using a limited input device to navigate through a plurality of user interface (UI) control elements included in a video content field as recited in claim 22 wherein activating the second subset of the UI control elements substantially simultaneously de-activates the first subset of UI control elements and wherein activating the first subset of the UI control elements substantially simultaneously de-activates the second subset of UI control elements.

24. A computer-readable medium containing programming instructions for using a limited input device to navigate through a plurality of user interface (UI) control elements included in a video content field as recited in claim 21, wherein the host compute is coupled to a set top box.
